(19) United States
(12) Patent Application Publication
(10) Pub. No.: US 2006/0238124 A1
(43) Pub. Date: Oct. 26, 2006

(54) Dielectric layer, plasma display panel comprising dielectric layer, and method of fabricating dielectric layer

(76) Inventor: Sung-Hune Yoo, Suwon-si (KR)

Correspondence Address: Robert E. Bushnell;Suite 300, 1522 K Street, N.W., Washington, DC, 20005-1202, US

(21) Appl. No.: 11/405,550

(22) Filed: Apr. 18, 2006

(30) Foreign Application Priority Data
Apr. 22, 2005 (KR) 10-2005-0033536
Apr. 22, 2005 (KR) 10-2005-0033537

(51) Int. Cl. H01J 17/49

(52) U.S. Cl. 313/584; 313/585; 313/582

(57) ABSTRACT

A dielectric layer increases color temperature and contrast ratio, and prevents brightness reduction. A plasma display panel includes the dielectric layer. The dielectric layer includes a base glass and a transition metal compound. In the dielectric layer, the transmittance of visible light having a wavelength of 430 to 480 nm is greater than the transmittance of visible light having a wavelength of 530 to 560 nm or 580 to 660 nm.

### CLAIM OF PRIORITY

This application makes reference to, incorporates the same herein, and claims all benefits accruing under 35 U.S.C. § 19 from two applications for DIELECTRIC LAYER AND PLASMA DISPLAY PANEL COMPRISING THE SAME earlier filed in the Korean Intellectual Property Office on the 22^{nd} of Apr. 2005 and there, duly assigned Serial No. 10-2005-0033536 and 10-2005-0033537.

### BACKGROUND OF THE INVENTION

1. Technical Field

The present invention relates to a dielectric layer and, more particularly, to a dielectric layer which can increase color temperature and contrast ratio of a plasma display panel and does not have a yellowish color, a plasma display panel comprising the dielectric layer, and a method of fabricating the dielectric layer.

2. Related Art

A plasma display panel is a flat display device that displays desired numbers, letters, or graphics using light emitted from an excited phosphor material layer formed in a discharge space filled with a discharge gas. The phosphor material layer is excited by ultraviolet rays generated by applying a predetermined voltage between discharge electrodes respectively formed on a plurality of substrates facing each other.

The plasma display panel includes a panel having a first panel and a second panel, barrier ribs which define discharge cells between the panels, a discharge gas filled in the discharge cells, a phosphor layer formed in the discharge cells, and a plurality of discharge electrodes to which a discharge voltage is applied.

In the case of a three-electrode surface discharge type plasma display panel, the first panel includes sustain discharge electrode pairs and a first dielectric layer which buries the sustain discharge electrode pairs, and the second panel includes address electrodes crossing the sustain discharge electrode pairs and a second dielectric layer which buries the address electrodes.

The barrier ribs are formed of PbO.B₂O₃.SiO₂ as a main component, similar to the dielectric layers. Accordingly, the barrier ribs are transparent. However, when visible light emitted from an external light source directly enters the discharge cells through the first panel, a portion of the visible light is reflected by the barrier ribs or the phosphor layer, and the remaining portion of the visible light is transmitted through the barrier ribs or the phosphor layer. The external visible light which is reflected by the barrier ribs or the phosphor layer, or which is transmitted through the barrier ribs or the phosphor layer, interferes with the visible light generated from the plasma display panel to display desired images, and thus reduces the contrast ratio of the plasma display panel.

To solve the above problems, a black stripe (BS) layer can be applied to the first panel where the visible light is emitted. However, in this case, the degree of freedom for designing discharge electrodes in the first panel is limited, and a bus electrode is included in the discharge electrodes and is disposed in the discharge space, thereby reducing brightness. Alternatively, a coloring agent can be applied to the first dielectric layer disposed in the first panel. In this case, the transmittance of the visible light is reduced, thereby reducing brightness.

In prior arrangements, the dielectric layer is formed of a neutral gray dielectric or a blue dielectric. When a neutral gray dielectric is used, the reflection of external light is greatly reduced, but the increase in the color temperature of the plasma display panel is small. When a blue dielectric is used, the reflection of external light is greatly reduced and the color temperature is greatly increased, but visible light emitted from the plasma display panel has a bluish tint, which is different from the bluish white color which most people like, thereby degrading the appearance quality of the plasma display panel.

Also, in prior arrangements, due to the brightness differences of visible light emitted from plasma display panels, the color temperature of the plasma display panels is reduced.

Moreover, when the bus electrode is a silver electrode, Ag ions are generated by the silver electrode during a firing process of the dielectric layer or the panel, and thus a yellowish phenomenon of the dielectric layer occurs, that is, the color of the dielectric layer becomes yellowish due to Ag ions being diffused into the dielectric layer and precipitated in the pores of the dielectric layer.

### SUMMARY OF THE INVENTION

The present invention provides a dielectric layer which is formed in a panel through which visible light is emitted, and which prevents a reduction in brightness due to external light reflection in a plasma display panel due to the existence of a color agent in the dielectric layer.

Thus, the invention provides an increased contrast ratio in the plasma display panel. The invention also provides a plasma display panel comprising the dielectric layer, and a method of fabricating the dielectric layer.

The present invention further provides a dielectric layer which increases color temperature and prevents brightness reduction by optimizing the transmittance of visible light at each wavelength by controlling the type and composition of a color agent when the color agent is applied to the dielectric layer formed in a panel which emits visible light. As mentioned above, the invention also provides a plasma display panel comprising the dielectric layer, and a method of fabricating the plasma display panel comprising the dielectric layer.

The present invention further provides a dielectric layer in which a yellowish phenomenon is prevented, the yellowish phenomenon being caused by diffusion and precipitation of Ag ions generated by a silver electrode during a firing process. In accordance with the invention, an appropriate type of color agent is selected for application to the dielectric layer, and a plasma display panel comprising the dielectric layer, and a method of fabricating the plasma display panel comprising the dielectric layer, are also provided.

According to an aspect of the present invention, a dielectric layer of a plasma display panel comprises: a base glass; and a transition metal compound; wherein the transmittance of visible light having a wavelength of 430 to 480 nm is greater than the transmittance of visible light having a wavelength of 530 to 560 nm, or the transmittance of visible light having a wavelength of 580 to 660 nm.

According to another aspect of the present invention, a plasma display panel comprises: a first substrate through which visible light is emitted; a second substrate which is separated from the first substrate, and which faces the first substrate; barrier ribs disposed between the first and second substrates so as to define discharge cells which are spaces in which discharge occurs; a plurality of discharge electrode pairs which are disposed between the first and second substrates and separated from each other, and which cause gas discharges in the discharge cells through mutual action; a first dielectric layer disposed on the first substrate so as to bury the discharge electrodes; a phosphor layer disposed in the discharge cell; and a discharge gas filling the discharge cell. The first dielectric layer comprises a base glass and a transition metal compound, wherein the transmittance of visible light having a wavelength of 430 to 480 nm is greater than the transmittance of visible light having a wavelength of 530 to 560 nm, or the transmittance of visible light having a wavelength of 580 to 660 nm.

According to another aspect of the present invention, a dielectric layer of a plasma display panel is formed by adding a Cu group oxide to a base glass. The invention also relates to a plasma display panel having the dielectric layer, and a method of fabricating the same.

According to the present invention, a method of fabricating a dielectric layer of a plasma display panel comprises: forming glass to which a Cu group oxide is added; grinding the glass into a glass powder; forming a dielectric paste by mixing the glass powder with a binder and a solvent; printing the dielectric paste on a substrate; and firing the dielectric paste printed on the substrate.

According to another aspect of the present invention, a method of fabricating a dielectric layer of a plasma display panel comprises: forming glass to which a Cu group oxide is added; grinding the glass into a glass powder; forming a green sheet in which the glass powder is solidified; coating the green sheet on a substrate using a laminating process; and firing the green sheet formed on the substrate.

According to a further aspect of the present invention, a plasma display panel comprises: a first substrate through which visible light is emitted; a second substrate which is separated from the first substrate and which faces the first substrate; barrier ribs which are disposed between the first and second substrates, and which define discharge cells which are spaces in which discharge occurs; a plurality of discharge electrode pairs which are disposed between the first and second substrate, separated from each other, and which generate a gas discharge in the discharge cell through mutual action; a first dielectric layer disposed in the first substrate so as to bury the discharge electrodes; a phosphor layer disposed in the discharge cell; and a discharge gas filling the discharge cell. The first dielectric layer is composed of a base glass which comprises a Cu group oxide, and the base glass which forms the first dielectric layer comprises a Cu group oxide. The invention also relates to a method of fabricating the dielectric layer and the plasma display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a graph showing the transmission spectrum of a dielectric layer according to an embodiment of the present invention;

FIG. 2 is an exploded partial perspective view of a plasma display panel according to an embodiment of the present invention;

FIG. 3 is a cross-section view taken along sectional line III-III of FIG. 2; and

FIG. 4 is a flowchart of a method of fabricating a dielectric layer according to an embodiment of the present invention.

### DETAILED DESCRIPTION OF THE INVENTION

The present invention will now be described more fully with reference to accompanying drawings in which exemplary embodiments of the present invention are shown.

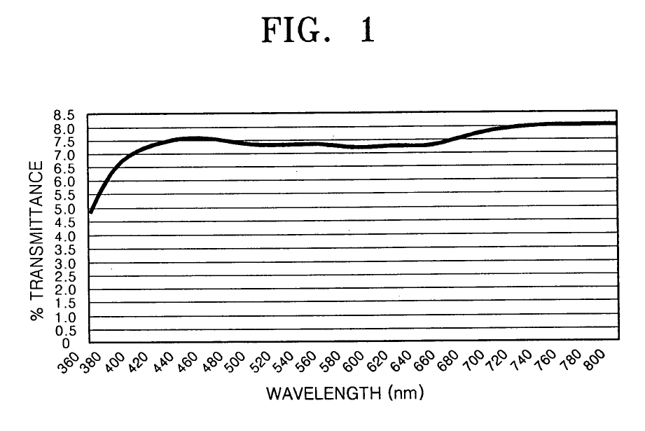

FIG. 1 is a graph showing the transmission spectrum of a dielectric layer according to an embodiment of the present invention.

In a plasma display panel, a phosphor layer formed of a red, green or blue phosphor material (hereinafter, RGB phosphor material) is formed in each discharge cell in which a gas discharge occurs.

Three consecutively adjacent discharge cells, that is, a discharge cell having a red (R) phosphor layer, a discharge cell having a green (G) phosphor layer, and a discharge cell having a blue (B) phosphor layer, constitute one unit pixel through mutual action.

In general, the brightness ratio between the RGB phosphor materials is approximately 28:62:10, and the color temperature of a peak generated in a unit pixel is approximately 8,000 K.

Typically, the larger the deviation between each of the brightness ratios in connection with the brightness ratio of the RGB phosphor materials, the lower the color temperature.

The color temperature represents how hot or cold the color is, and usually, the color temperature can be controlled between 6,500 K and 9,300 K. K is absolute temperature unit. A higher color temperature represents a brighter, colder, and more bluish color. A lower color temperature represents a warmer and more reddish color. The preference of color temperature differs from person to person, but most people prefer a bluish-white high color temperature.

However, in the prior art, since the blue (B) phosphor material has a relatively low brightness, to compensate the color temperature to a level that most people prefer, the brightness of the red (R) and green (G) phosphor materials must be reduced. The compensation of the color temperature through the reduction of the brightness results in the reduction of the overall brightness of the plasma display panel.

To solve the above problem, referring to FIG. 1, in a dielectric layer of a plasma display panel according to an embodiment of the present invention, the transmittance T %₄₃₀₋₄₈₀ of visible light having a wavelength in a range of 430 to 480 nm is greater than the transmittance T %₅₃₀₋₅₆₀ of visible light having a wavelength in a range of 530 to 560 nm or the transmittance T %₅₈₀₋₆₆₀ of visible light having a wavelength in a range of 580 to 660 nm, and T %₅₁₀₋₅₆₀ is equal to T %₆₄₀₋₆₆₀.

In this way, the transmittance, i.e., T %₄₃₀₋₄₈₀, of blue light is greater than the transmittance, i.e., T %₅₈₀₋₆₆₀, of red light and the transmittance, i.e., T %₅₃₀₋₅₆₀, of green light. Accordingly, the color temperature of the plasma display panel can be increased since the brightness ratio between different colors of visible light is reduced.

Also, T %₄₃₀₋₄₈₀-T %₅₃₀₋₅₆₀ (or T %₅₈₀₋₆₆₀) is controlled so as to be in a range of 3.5% to 6.5%. That is, the reduction in the overall brightness of the visible light emitted from the RGB phosphor materials can be prevented by setting a predetermined limit, below which the transmittance T %₅₃₀₋₅₆₀ of the green light, which occupies approximately 60% of the overall brightness, is not excessively reduced.

To control the transmittance of visible light at each wavelength as described above, the dielectric layer of the plasma display panel according to an embodiment of the present invention is formed by adding a transition metal compound, such as a Co group oxide, an Ni group oxide or a Cu group oxide (for example, CuO), to a base glass, but the present invention is not limited thereto. That is, the dielectric layer can be formed by adding various other transition metal compounds to a base glass so long as the same result is obtained.

The transition metal compound, i.e., the Co group oxide, the Ni group oxide or the Cu group oxide, functions as a color agent. Therefore, the transition metal compound reduces the brightness of reflected external light, that is, the brightness of visible light which enters the plasma display panel from an external light source and which is emitted to the outside of the plasma display panel after being reflected by transparent barrier ribs or a phosphor layer in the plasma display panel. Accordingly, interference of the reflected external light with the visible light used to realize desired images as described above is reduced. Therefore, the contrast ratio of a plasma display panel can be greatly increased by forming the dielectric layer with the transition metal compound.

More specifically, when the dielectric layer of a plasma display panel is formed by adding a transition metal compound, such as a Co group oxide, an Ni group oxide or a Cu group oxide, as the color agent described above, and by optimizing the transmittance of visible light at each wavelength by controlling the composition of the color agent, the plasma display panel has a high contrast ratio due to the reduction of brightness of reflected external light, a high brightness due to the prevention of the reduction of transmittance, and a high color temperature.

However, the optimization of the transmittance of visible light at each wavelength by controlling the type or composition of the color agent added to the dielectric layer is insufficient to achieve the increase in the contrast ratio, the prevention of brightness reduction, and the increase in the color temperature, which are objects of the present invention.

Therefore, attempts to optimize the transmittance of visible light at each wavelength have been conducted. As a result, in accordance with the object of the present invention, it is desirable that, in the region of visible light having a wavelength between 400 nm and 480 nm, the difference between transmittance of the visible light from and that of another visible light be within 5%. Also, in the region of the visible light having a wavelength in a range between 560 nm and 660, the transmittance of visible light is not greater than the transmittance of visible light having a wavelength of 560 nm or 660 nm, but, in this region, the difference between transmittance of visible light and that of another visible light should be within 3%.

When the conditions of the transmittance of visible light at each wavelength are met, as shown in Table 1, the dielectric layer can have a predetermined color between violet and blue-black which is appropriate to achieve the object of the present invention. If one of the conditions is not met, the dielectric layer can have a blue color or another color other than the desired color, thereby reducing the contrast ratio.

Thus, the dielectric layer which has transmittance of visible light at each of the specifically optimized wavelengths may have an intermediate color between violet and blue-black color.

Also, various attempts to obtain the embodiment of the present invention as described above have been conducted, and the results of comparing the embodiment of the present invention to a conventional dielectric layer (comparative example 1) are summarized in Table 1.

TABLE 1

| | Comparative | | | |
|---|---|---|---|---|
| | example 1 | | | |
| | (conventional | | Comparative | Comparative |
| | dielectric layer) | Embodiment | example 2 | example 3 |
| Brightness reduction | — | 11% | 16% | 23% |
| rate (Lp) | | | | |
| Brightness reduction | — | 30% | 18% | 32% |
| rate of reflected | | | | |
| external light (Li) | | | | |
| Bright room contrast | — | 2.73 | 1.13 | 1.39 |
| ratio (Li/Lp) | | | | |
| Color | Transparent | Violet + Blue-black | Blue | Black + Yellow |

That is, the dielectric layer according to an embodiment of the present invention produced identical results when the final color of the dielectric layer was a predetermined color between violet and blue-black, more specifically, an intermediate color, regardless of the method used to control the transmittance of visible light at each wavelength.

The transition metal compound, such as a Co group oxide, a Ni group oxide, or a Cu group oxide, may be incorporated into a base glass when manufacturing the base glass. In this case, a reduction in transmittance, which occurs due to scattering in a conventional dielectric layer formed of a mixture of the transition metal compound as a color agent and glass powder, can be prevented. That is, in the present embodiment, a color agent is previously added when preparing glass powder to obtain a glass powder of a color.

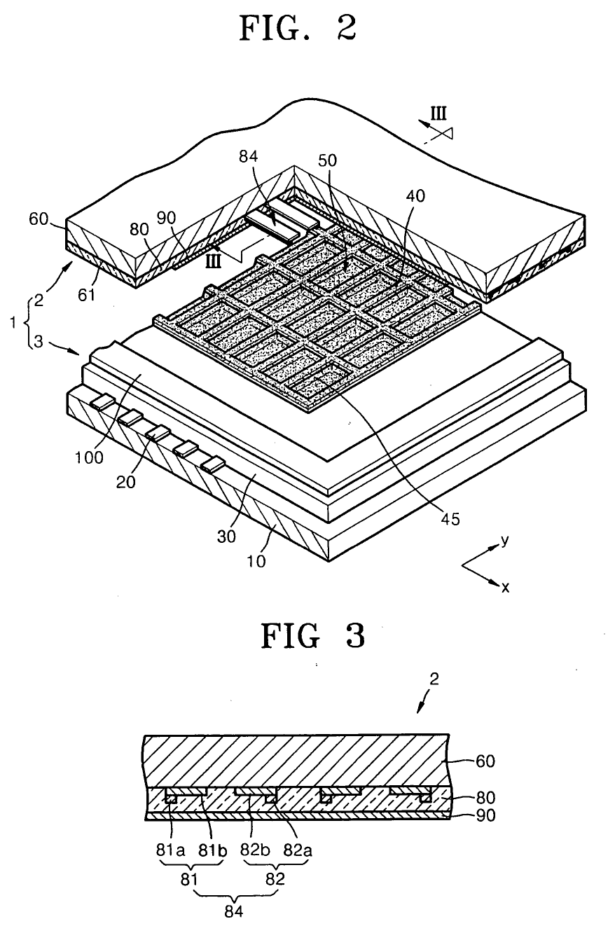

FIG. 2 is a cutaway exploded perspective view of a plasma display panel according to an embodiment of the present invention, and FIG. 3 is a cross-section view taken along line III-III of FIG. 2.

Referring to FIGS. 1 and 2, the plasma display panel 1 includes a first panel 2 and a second panel 3. The first panel 2 includes a first substrate 60, sustain discharge electrode pairs 84 disposed on an inner surface 61 of the first substrate 60, and a first dielectric layer 80 covering the sustain discharge electrode pairs 84.

The sustain discharge electrode pairs 84 can include an X electrode 81 and a Y electrode 82 which includes transparent electrodes 81b and 82b, respectively, and bus electrodes 81a and 82a, respectively.

The second panel 3 includes a second substrate 10, barrier ribs 40, a phosphor layer and discharge cells 50 filled with a discharge gas.

Discharge cells 50, which form a discharge space, are defined by the barrier ribs 40, the first panel 2 and second panel 3.

The plasma display panel 1 can further include address electrodes 20 crossing the sustain discharge electrode pairs 84.

In this case, a second dielectric layer 30 can be disposed between phosphor layer 45 and the second substrate 10, and the address electrodes 20 can be disposed within the second dielectric layer 30.

The plasma display panel 1 can further include a protective layer 90 covering at least a portion of the first dielectric layer 80.

The plasma display panel 1 may also include a sealing member 100 which combines the first panel 2 and second panel 3 in an air-tight manner. The sealing member 100 is disposed along the edges where the first panel 2 and second panel 3 overlap. The sealing member 100 may be formed of frit glass.

According to an embodiment of the present invention, the first dielectric layer 80 is preferably a dielectric layer which transmits visible light at each of the optimized wavelengths as depicted in FIG. 1 by adding a transition metal compound as a color agent.

The advantages that are obtained from the plasma display panel 1 having the first dielectric layer 80 according to an embodiment of the present invention are the same as described above.

The base glass, which is a main component of the dielectric layer, is amorphous, and includes some pores within its bonding structure since the bonding between components of the base glass is not dense.

When the electrodes included in the plasma display panel 1 are silver electrodes, silver atoms are ionized during a firing process for forming the silver electrodes or a firing process for forming the dielectric layer, and the silver ions can diffuse into the pores in the dielectric layer and precipitate in the pores, resulting in the dielectric layer being yellowish.

However, when the transition metal compound, such as the Co group oxide, the Ni group oxide, or the Cu group oxide, is added to the base glass, the diffusion of the silver ions generated from the silver electrode into the dielectric layer is prevented due to a peening effect in which the transition metal compound blocks the pores formed within the base glass, thereby preventing the dielectric layer from becoming yellowish.

That is, as described above, by forming the dielectric layer of a plasma display panel by adding a transition metal compound such as a Co group oxide, an Ni group oxide, or a Cu group oxide as the color agent as described above, and by optimizing the transmittance of visible light at each wavelength by controlling the composition of the color agent, a plasma display panel with a high contrast ratio due to low brightness of reflected external light has high brightness since visible light transmittance is not reduced, has a high color temperature, and does not produce an image with a yellowish tint.

However, the optimization of the transmittance of visible light at each wavelength by controlling the kind and composition of the color agent added to the dielectric layer by itself is insufficient to prevent the reduction of transmittance of the dielectric layer caused by adding the color agent.

To fundamentally prevent the reduction of the transmittance of the dielectric layer, the transmittance of the base glass itself is increased. To achieve this goal, the base glass may include 30-50 wt % PbO, 1-15 wt % SiO₂, 5-35 wt % B₂O₃, 1-15 wt % Al₂O₃, 5-35 wt % BaO and 1-15 wt % TiO₂.

In this respect, the base glass may contain PbO, B₂O₃ and BaO as main components, but the present invention is not limited thereto.

Co₂O₃ may be added to the dielectric layer as a Co group oxide, but the present invention is not limited thereto.

Furthermore, 1.3 to 1.5 parts by weight of the Co group oxide per 1 part by weight of a Cu group oxide may be added to the base glass, but the present invention is not limited thereto.

In addition, a Cu group oxide such as CuO may be added to the base glass within a range of 0.1 to 1% by weight based on the total weight, including the weight of the base glass, but the present invention is not limited thereto.

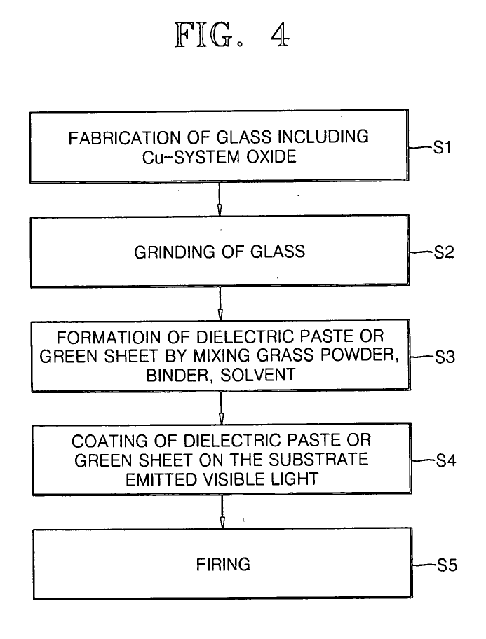

A method of fabricating a dielectric layer of a plasma display panel according to an embodiment of the present invention is shown in FIG. 4.

FIG. 4 is a flowchart of a method of fabricating a dielectric layer of a plasma display panel according to an embodiment of the present invention.

Referring to FIG. 4, 0.1 to 1% by weight of a Cu group oxide, such as CuO, or 0.13 to 1.5% by weight of a Co group oxide is added to a base glass so as to fabricate glass (S1). When the glass is fabricated in this way, the reduction in transmittance caused by scattering, which inevitably occurs in a conventional dielectric layer formed of a mixture of a transition metal compound as a color agent and glass powder, is prevented. That is, in the present embodiment, a color agent is previously added when preparing glass powder to obtain a glass powder of a color.

Next, the glass is ground to a glass powder including grains having a diameter of 0.1 to 10 μm (S2). Then, a dielectric paste is formed by mixing the glass powder with a binder, such as ethyl-cellulose, and a solvent, such as alpha-terpineol or buthyl-cabitol-acethe (BCA), in a container (S3).

Next, the dielectric paste is coated on a first substrate, through which visible light of the plasma display panel is emitted, using a screen printing method or a thick film coating method (S4). The resultant product is them fired (S5).

Alternatively, after the dielectric paste is molded using a doctor blade method, a green sheet (or a green tape) is formed by drying the dielectric paste. Afterward, the green sheet is attached to the first substrate through a laminating process, and then the firing process is performed. The firing is preferably performed at a temperature of 400 to 800° C. for 5 to 60 minutes.

In this way, the dielectric layer is formed by adding a Cu group oxide, such as CuO, or a Co group oxide to the first substrate.

According to the present invention, a plasma display panel which can reduce the brightness of reflected external light, and accordingly, which can greatly increase the contrast ratio, can be provided by adding a color agent to a dielectric layer disposed in the panel which emits visible light.

Also, according to the present invention, when the color agent is added to the dielectric layer disposed in the panel which emits visible light, a plasma display panel with a high color temperature, and with high brightness due to the optimization of the transmittance of visible light at each wavelength, can be provided by controlling the type and composition of the color agent.

Also, according to the present invention, a plasma display panel having a dielectric layer which can be prevented from being yellowish, due to the diffusion of silver ions into the dielectric layer during a firing process when a silver electrode is used in a plasma display panel, can be provided by appropriately selecting the type of the color agent employed in the dielectric layer as described above.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A dielectric layer of a plasma display panel, said dielectric layer comprising:
a base glass; and
a transition metal compound;
wherein a transmittance of visible light having a wavelength in a range of 430 nm to 480 nm is greater than a transmittance of visible light having one of a wavelength in a range of 530 nm to 560 nm and a wavelength in a range of 580 nm to 660 nm.

2. The dielectric layer of claim 1, wherein a transmittance of visible light having a wavelength in a range of 510 nm to 560 nm is identical to a transmittance of visible light having a wavelength in a range of 640 nm to 660 nm.

3. The dielectric layer of claim 1, wherein a difference between the transmittance of the visible light having the wavelength in the range of 430 nm to 480 nm and the transmittance of the visible light having the wavelength in the range of 530 nm to 560 nm is in a range of 3.5% to 6.5%.

4. The dielectric layer of claim 1, wherein a variation in a transmittance of visible light having a wavelength in a range of 400 nm to 480 nm is less than 5%.

5. The dielectric layer of claim 1, wherein, in a region of visible light having a wavelength in a range of 560 nm to 660 nm, a transmittance of each visible light is not greater than a transmittance of visible light having a wavelength of one of 560 nm and 660 nm.

6. The dielectric layer of claim 5, wherein a variation in transmittance of visible light having a wavelength in a range of 560 nm to 660 nm is less than 3%.

7. The dielectric layer of claim 1, further comprising a dielectric layer having a predetermined color between violet and blue-black color.

8. The dielectric layer of claim 1, wherein the transition metal compound is added to the base glass during a fabrication process of the base glass so as to form the transition metal compound in one unit with the base glass.

9. The dielectric layer of claim 1, wherein the transition metal compound comprises an Ni group oxide.

10. The dielectric layer of claim 1, wherein the transition metal compound comprises a Co group oxide.

11. A plasma display panel, comprising:
a first substrate through which visible light is emitted;
a second substrate which is separated from the first substrate and which faces the first substrate;
barrier ribs disposed between the first and second substrates and defining discharge cells comprising spaces in which discharge occurs;
a plurality of discharge electrode pairs which are disposed between the first and second substrates and which are separated from each other, and which cause gas discharges in the discharge cells through mutual action;
a first dielectric layer disposed on the first substrate so as to bury the discharge electrodes;
a phosphor layer disposed in the discharge cells; and
a discharge gas contained in the discharge cells;
wherein the first dielectric layer comprises a base glass and a transition metal compound, and wherein a transmittance of visible light having a wavelength in a range of 430 nm to 480 nm is greater than a transmittance of visible light having one of a wavelength in a range of 530 nm to 560 nm and a wavelength in a range of 580 nm to 660 nm.

12. The plasma display panel of claim 11, wherein a transmittance of visible light having a wavelength in a range of 510 nm to 560 nm is identical to a transmittance of visible light having a wavelength in a range of 640 nm to 660 nm.

13. The plasma display panel of claim 11, wherein a difference between the transmittance of the visible light having the wavelength in the range of 430 nm to 480 nm and the transmittance of the visible light having the wavelength in the range of 530 nm to 560 nm is in a range of 3.5% to 6.5%.

14. The plasma display panel of claim 11, wherein a variation in a transmittance of visible light having a wavelength in a range of 400 nm to 480 nm is less than 5%.

15. The plasma display panel of claim 11, wherein, in a region of visible light having a wavelength in a range of 560 nm to 660 nm, a transmittance of each visible light is not greater than a transmittance of the visible light having a wavelength of one of 560 nm and 660 nm.

16. The plasma display panel of claim 11, wherein a variation in a transmittance of visible light having a wavelength in a range of 460 nm to 660 nm is less than 3%.

17. The plasma display panel of claim 11, wherein the dielectric layer has a predetermined color between violet and blue-black color.

18. A dielectric layer of a plasma display panel, the dielectric layer comprising a Cu group oxide which is added to a base glass to form the dielectric layer.

19. The dielectric layer of claim 18, wherein the Cu group oxide added to the base glass is CuO.

20. The dielectric layer of claim 18, wherein a Co group oxide is further added to the base glass.

21. The dielectric layer of claim 18, wherein 1.3 to 1.5 parts by weight of a Co group oxide per 1 part by weight of the Cu group oxide are added to the base glass.

22. The dielectric layer of claim 18, wherein the base glass comprises the Cu group oxide within a range of 0.1 to 1% by weight of a total weight including a weight of the base glass.

23. The dielectric layer of claim 18, wherein the base glass comprises 30-50% by weight of PbO, 1-15% by weight of SiO₂, 5-35% by weight of B₂O₃, 1-15% by weight of Al₂O₃, 5-35% by weight of BaO, and 1-15% by weight of TiO₂.

24. The dielectric layer of claim 23, wherein the base glass contains PbO, B₂O₃ and BaO as main components.

25. A method of fabricating a dielectric layer of a plasma display panel, the method comprising the steps of:
forming glass;
adding a Cu group oxide to the glass;
grinding the glass into a glass powder;
forming a dielectric paste by mixing the glass powder with a binder and a solvent;
printing the dielectric paste on a substrate; and
firing the dielectric paste printed on the substrate.

26. The method of claim 25, wherein the glass further comprises a Co group oxide.

27. The method of claim 25, wherein 1.3 to 1.5 parts by weight of a Co group oxide per one part by weight of the Cu group oxide are added to the glass.

28. The method of claim 25, wherein the Cu group oxide has a weight in a range of 0.1 to 1% by weight of a total weight including a weight of the glass.

29. A method of fabricating a dielectric layer of a plasma display panel, the method comprising the steps of:
forming glass;
adding a Cu group oxide to the glass;
grinding the glass into a glass powder;
forming a green sheet in which the glass powder is solidified;
coating the green sheet on a substrate using a laminating process; and
firing the green sheet formed on the substrate.

30. The method of claim 29, wherein the glass further comprises a Co group oxide.

31. The method of claim 29, wherein 1.3 to 1.5 parts by weight of a Co group oxide per one part by weight of the Cu group oxide are added to the glass.

32. The method of claim 29, wherein the Cu group oxide has a weight in a range of 0.1 to 1% by weight of a total weight including a weight of the glass

33. A plasma display panel, comprising:
a first substrate through which visible light is emitted;
a second substrate which is separated from the first substrate and which faces the first substrate;
barrier ribs disposed between the first and second substrates and defining discharge cells comprising spaces in which discharge occurs;
a plurality of discharge electrode pairs which are disposed between the first and second substrate and which are separated from each other, and which generate a gas discharge in the discharge cells through mutual action;
a first dielectric layer disposed in the first substrate so as to bury the discharge electrodes;
a phosphor layer disposed in the discharge cells; and
a discharge gas contained in the discharge cells;
wherein the first dielectric layer is composed of a base glass which comprises a Cu group oxide.

34. The plasma display panel of claim 33, wherein the Cu group oxide comprises CuO.

35. The plasma display panel of claim 33, wherein the discharge electrodes are silver electrodes.

36. The plasma display panel of claim 33, wherein the base glass further comprises a Co group oxide.

37. The plasma display panel of claim 33, wherein 1.3 to 1.5 parts by weight of a Co group oxide per one part by weight of the Cu group oxide are added to the glass.

38. The plasma display panel of claim 33, wherein the Cu group oxide has a weight within a range of 0.1 to 1% by weight of a total weight including a weight of the base glass.

39. The plasma display panel of claim 33, wherein the base glass comprises 30-50% by weight of PbO, 1-15% by weight of SiO₂, 5-35% by weight of B₂O₃, 1-15% by weight of Al₂O₃, 5-35% by weight of BaO, and 1-15% by weight of TiO₂.

40. The plasma display panel of claim 39, wherein the base glass contains PbO, B₂O₃ and BaO as main components.
